(19) United States
(12) Patent Application Publication
(10) Pub. No.: US 2003/0089463 A1
(43) Pub. Date: May 15, 2003

(54) Pressure vent hurricane shutter

(76) Inventors: Thomas R. Briscoe, Naples, FL (US); Harley E. Briscoe, Naples, FL (US)

Correspondence Address: Merrill N. Johnson, 800 Harbour Drive, Naples, FL, 34103, US

(21) Appl. No.: 09/966,622

(22) Filed: Oct. 1, 2001

(51) Int. Cl. E06B 3/48

(52) U.S. Cl. 160/117

(57) ABSTRACT

A pressure-vent hurricane shutter has predetermined requisite strength of shutter framework (1) encompassing slatted-louver apertures (4) for protection against storm-borne objects, wind and rain in addition to venting damaging buildups and bursts of pressure and vacuum that react on buildings from hurricanes. The shutter framework includes structural beams to which ends of slanted slats (5) are attached rigidly and to which ends of slat-support mullions (7) are affixed intermediate the ends of inward edges (6) of the slanted slats. The shutter framework is hinged with the requisite strength to at least one side of a building aperture in accordance with desired shutter style and structure which include top-hinged Bahama Shutters (8) and sides-hinged Colonial Shutters (9).

### FIELD OF THE INVENTION

1. Field of the Invention.

This invention relates to hurricane shutters and more particularly to a hurricane shutter that protects requisitely against storm-borne objects, wind and rain while also venting buildups and bursts of pressure and vacuum that react on buildings from hurricanes and other severe storms.

### BACKGROUND OF THE INVENTION

2. Relation to prior art.

Devastation form severe hurricanes has resulted in storm-area legal requirements and personal interest in adequate storm protection that also is attractive, convenient and, if possible, also low cost. Numerous storm-protective shutters have occurred as a result. None, however, vent buildups and bursts of pressure and vacuum that react on buildings from hurricanes in addition to providing requisite protection against storm-borne objects, wind and rain in a manner taught by this invention.

Examples of most-closely related known but different devices are described in the following patent documents:

| Number | Date | Inventor | U.S. Classification |
|---|---|---|---|
| U.S. Pat. No. 5,907,929 | Jun. 1999 | Poma et at. | 52/78 |
| U.S. Pat. No. 5,617,683 | Apr. 1997 | Ney | 52/202 |
| U.S. Pat. No. 4,368,594 | Jan. 1983 | Milam et al. | 49/67 |
| U.S. Pat. No. 2,013,824 | Sep. 1935 | Ensminger | 20/55 |
| U.S. Pat. No. 1,646,522 | Oct. 1927 | Berg | |

The Poma et al. shutter required a removable rigid support for requisite protection. Shutters described by Ney, Milan et al., Ensminger and Berg shutter did not have pressure venting as taught by this invention.

### SUMMARY OF THE INVENTION

Objects of patentable novelty and utility taught by this invention are to provide a pressure-vent hurricane shutter which:

vents damaging buildups and bursts of pressure and vacuum that react on buildings from hurricanes;

provides legally requisite protection against storm-borne objects, wind and rain;

can be made attractive in a variety of structural styles; and

can be cost-effective for the level of protection provided.

This invention accomplishes these and other objectives with a pressure-vent hurricane shutter having preferably at least legally-requisite strength of framework encompassing slatted-louver apertures for protection against storm-borne objects, wind and rain in addition to venting damaging buildups and bursts of pressure and vacuum that react on buildings from hurricanes. The framework includes structural beams to which ends of slanted slats are attached rigidly and to which ends of slat-support mullions are affixed between the ends of inward edges of the slanted slats. The framework is hinged with the requisite strength to at least one side of a building aperture in accordance with desired shutter style and structure which include top-hinged Bahama and sides-hinged Colonial styles.

### BRIEF DESCRIPTION OF DRAWINGS

This invention is described by appended claims in relation to description of a preferred embodiment with reference to the following drawings which are explained briefly as follows:

FIG. 1 is a partially cutaway front elevation view of a Bahama-Shutter embodiment;

FIG. 2 is a is a section view through section line 1-1 of FIG. 1;

FIG. 3 is a is a section view through section line 2-2 of FIG. 1;

FIG. 4 is an end view of a framework member;

FIG. 5 is an end view of a slat-support mullion;

FIG. 6 is a partially cutaway side elevation view of a Bahama-Shutter embodiment; mounted on a generally wooden frame and being in an open mode;

FIG. 7 is the FIG. 6 illustration in a closed mode;

FIG. 8 is a partially cutaway side elevation view of a Bahama-Shutter embodiment; mounted on a generally concrete frame and being in an open mode;

FIG. 9 is the FIG. 8 illustration in a closed mode;

FIG. 10 is a front elevation view of a colonial-shutter embodiment having triple-louver sections for doors and large windows in a closed mode;

FIG. 11 is a front elevation view of a colonial-shutter embodiment having double-louver sections for average-sized doors and windows in a closed mode;

FIG. 12 is a fragmentary view of a colonial-shutter hinge shown hinging two portions of the colonial shutter together;

FIG. 13 is a fragmentary end view of a preferred shutter hinge that can be used either horizontally for hang-hinging Bahama Shutters or vertically for swing-hinging Colonial Shutters;

FIG. 14 is an end view of a structure wing of the preferred shutter hinge that is shown in the FIG. 13 illustration;

FIG. 15 is an end view of a frame wing of the preferred shutter hinge that is shown in the FIG. 13 illustration;

FIG. 16 is a top view of the structure wing of the preferred shutter hinge that is shown in the FIG. 13 illustration;

FIG. 17 is a top view of the frame wing of the preferred shutter hinge that is shown in the FIG. 13 illustration;

FIG. 18 is a fragmentary side view of the preferred shutter hinge in which the structure wing is shown attached to a metallic or other rigid form as seen from a left side of the FIG. 13 illustration and the frame wing is shown from a bottom of the FIG. 13 illustration; and

FIG. 19 is a fragmentary side view of the preferred shutter hinge in which the structure wing is shown attached to a wooden or other less rigid form as seen from a top side of the FIG. 13 illustration and the frame wing is shown from the bottom of the FIG. 13 illustration.

### DESCRIPTION OF PREFERRED EMBODIMENT

Listed numerically below with reference to the drawings are terms used to describe features of this invention. These terms and numbers assigned to them designate the same features throughout this description.

```
  1. Shutter framework
  2. Face walls
  3. Edge walls
  4. Slatted-louver apertures
  5. Slanted slats
  6. Inward edges of slats
  7. Slat-support mullions
  8. Bahama Shutters
  9. Colonial Shutters
10. Top hinge
11. Shutter frame
12. Wooden structure
13. Concrete frame
14. Shutter hinge
15. Colonial-shutter frame
16. Frame hinges
17. Structure wings
18. Frame wings
19. Shutter-hinge bolt
20. Hang structure
```

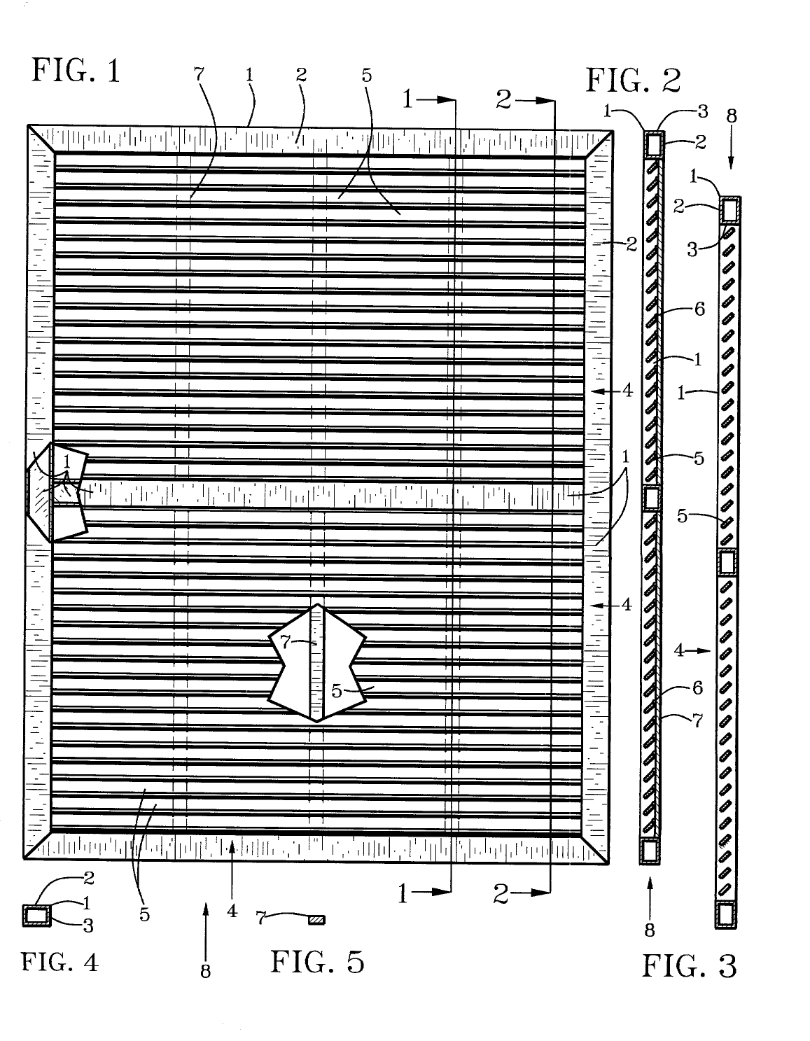

Referring to FIGS. 1-5, a pressure-vent hurricane shutter has it least one shutter framework 1 that includes structural beams that preferably are structural metal tubes having face walls 2 that are about two inches wide and edge walls 3 that are one-and-one-half inches wide. The face walls 2 and the edge walls 3 are about one-eighth inch thick and made preferably of structural aluminum alloy 6063-T52 or a substantial equivalent.

The substantial equivalent can be a ferrous alloy that is preferably stainless and rustproof with either an adequate coating or content of nickel, chrome, aluminum or other stainless constituent.

The shutter framework 1 encompasses slatted-louver apertures 4 having slanted slats 5 with slat ends affixed to the shutter framework 1. The slanted slats 5 have inward edges 6 that are oriented horizontally and attached to slat-support mullions 7. The slat-support mullions 7 are oriented vertically with ends attached to horizontal portions of the shutter framework 1. The inward edges 6 of the slanted slats 5 are orthogonal to the slat-support mullions 7.

The slatted-louver apertures 4 includes an entire slatted enclosure of a plurality of apertures between the slanted slats 5 and the shutter framework 1. The plurality of apertures individually are slanted with preferably about one-half inch of distance of slant orthogonally between surfaces of the slanted slats 5. The slanted slats 5 are preferably flat aluminum bar stock about one-quarter inch thick and one inch wide. Between bottoms and tops of adjacent slanted slats 5, there are horizontal apertures about one-eighth inch high and having a length that is a length of the slanted slats 5, less a width of the slat-support mullions 7.

A pressure-vent object of this hurricane shutter is to allow predeterminedly slight passage of wind and rain horizontally straight through slatted-louver apertures of the shutter framework 1 and slightly more directional-change passage while also providing structural strength to prevent breakage by storm-borne objects, wind and rain of hurricanes. Allowing directional-change passage of hurricane-force wind and rain while stopping large storm-borne objects and directional-change diversion of small objects like sand and small debris eliminates directly damaging aspects of hurricanes more effectively and much more cost-effectively than by totally stopping the hurricane-force wind and rain. Stopping them totally requires much stronger building structure. It also subjects the building structure to hurricane bursts of pressure and vacuum that react on buildings without reliable pressure-venting provided by this invention.

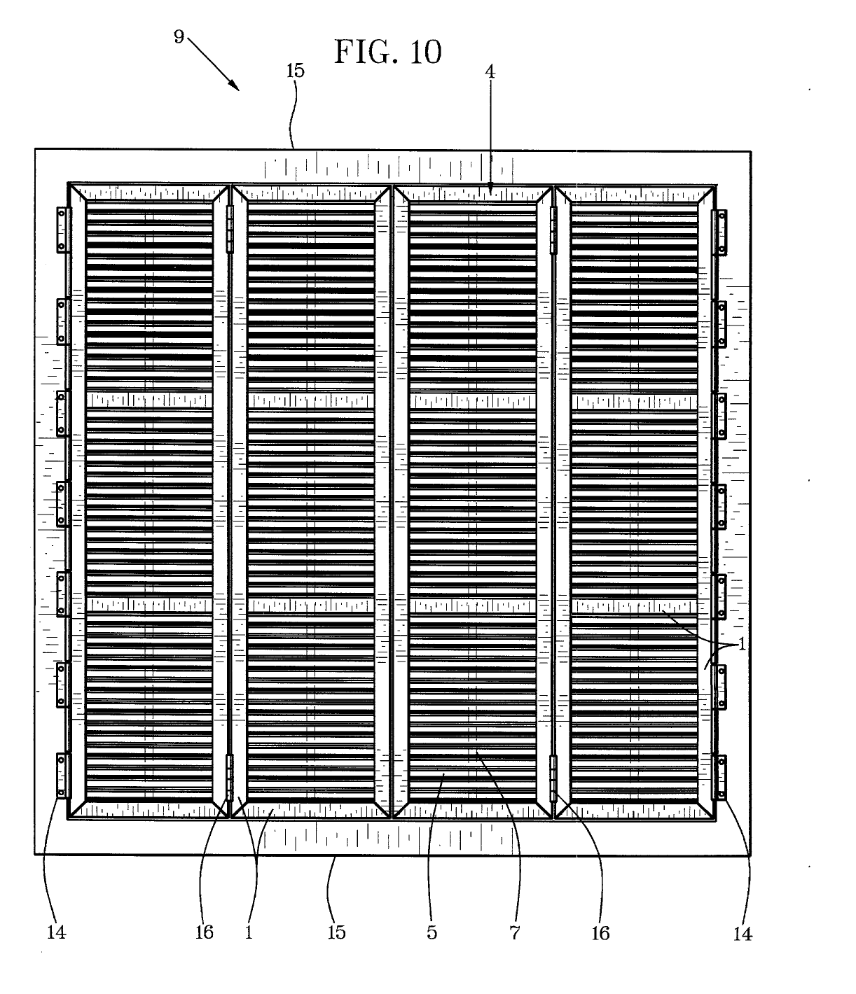

Included on fronts of slatted-louver apertures 4 of Bahama Shutters 8 shown in FIGS. 1-9 and Colonial Shutters 9 shown in FIGS. 10-12 are portions of the slatted-louver apertures 4 that are straight through horizontally between bottoms and tops of vertically adjacent slanted slats 5. Also shown are portions of slatted-louver apertures 4 that are slanted between the slanted slats 5 that are juxtaposed vertically.

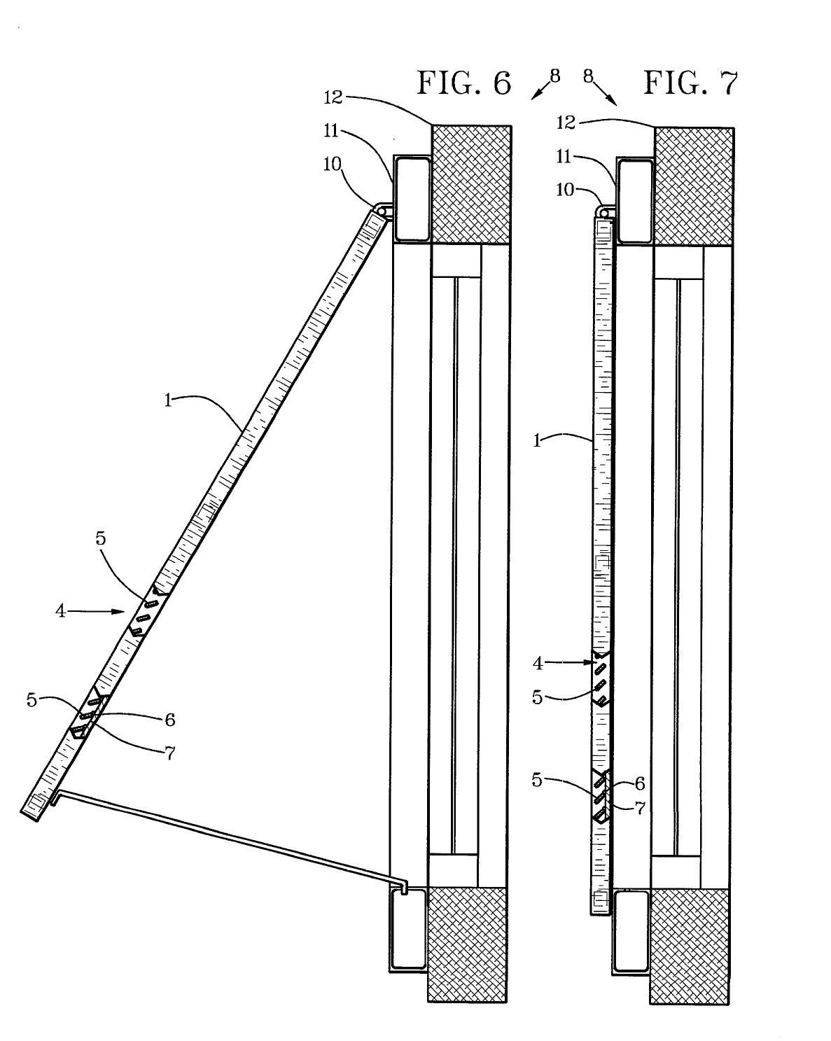

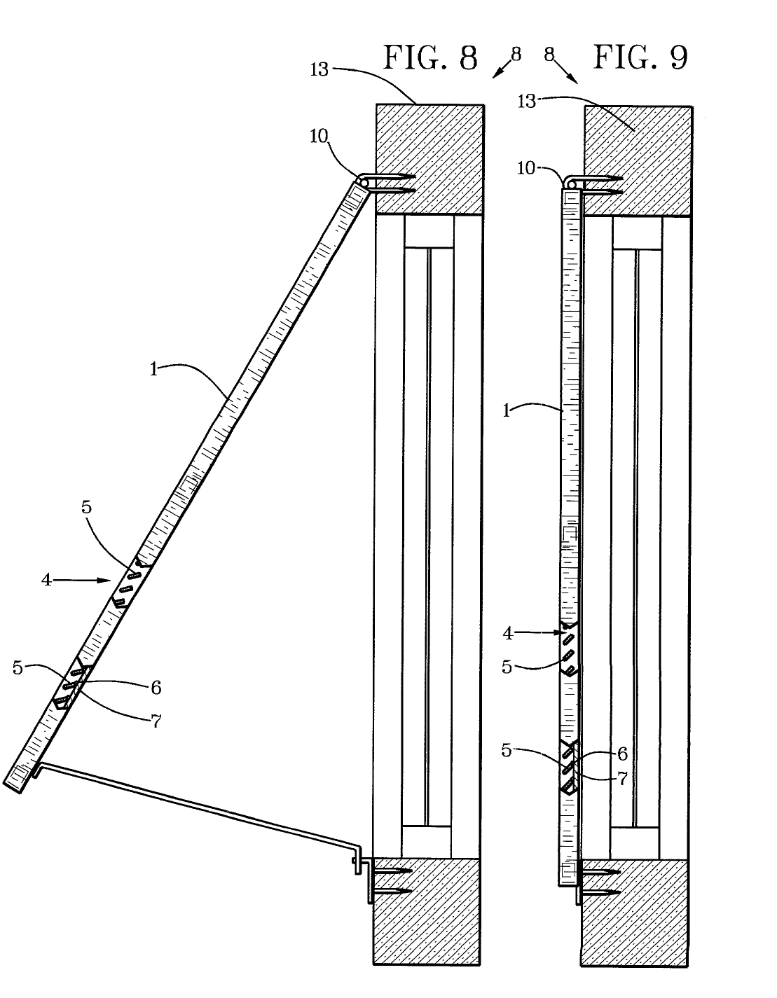

Referring to FIGS. 6-9, the shutter framework 1 is sized, shaped and designed predeterminedly for a Bahama Shutter 8 having a top hinge 10 with which it is hinged to the structural member which includes a shutter frame 11 on a building having wooden structure 12 shown in FIGS. 6-7 and which includes a concrete frame 13 on a building having concrete structure shown in FIGS. 8-9. The top hinge 10 is representative of a selection of Bahama-Shutter hinges having appropriate strength and operativeness for legal and other predetermined requisites for hinging hurricane shutters to building apertures.

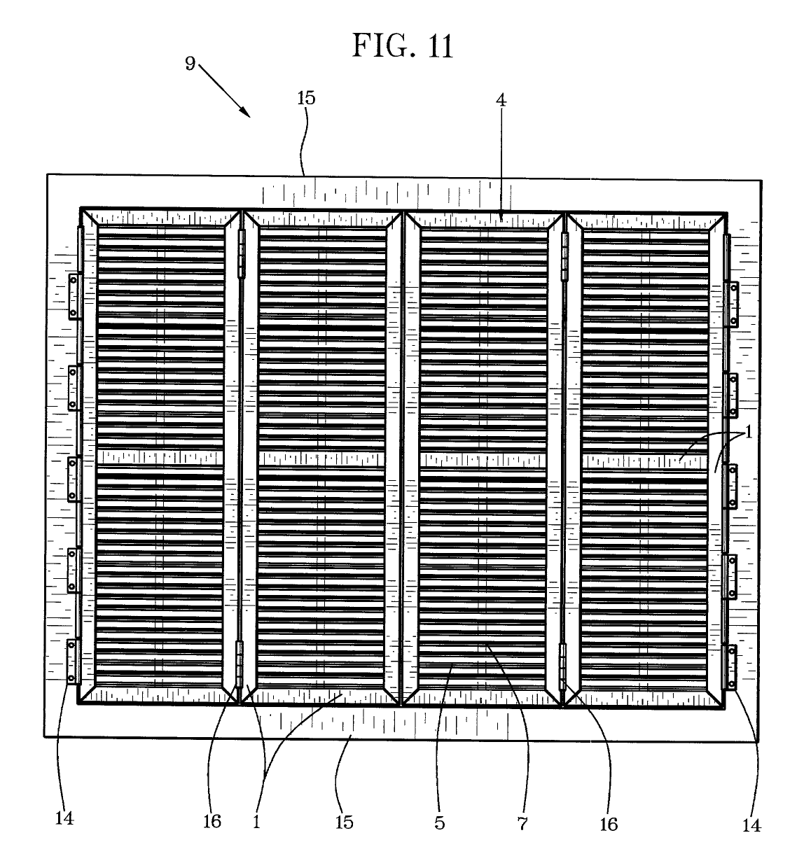

Referring to FIGS. 10-11, the shutter framework 1 is sized, shaped and designed predeterminedly for a Colonial Shutter 9 having a shutter hinge which includes shutter hinges 14 with which it is hinged to the structural member. The structural member includes a colonial-shutter frame 15 on the building. The Colonial Shutter 9 includes frame hinges 16 with which pluralities of the shutter frameworks 1 are hinged together for side-folding.

The colonial-shutter frame 15 is shown in two size and structural options that include two inside horizontal portions of the shutter framework 1 shown in FIG. 10 and one inside horizontal portion of the shutter framework 1 shown in FIG. 11. These options are for different sizes and shapes of building apertures in buildings. The building apertures in the buildings are not shown separately from structural members which include the shutter frame 15 in FIGS. 10-11, the wooden structure 12 in FIGS. 6-7 and the concrete frame 13 in FIGS. 8-9.

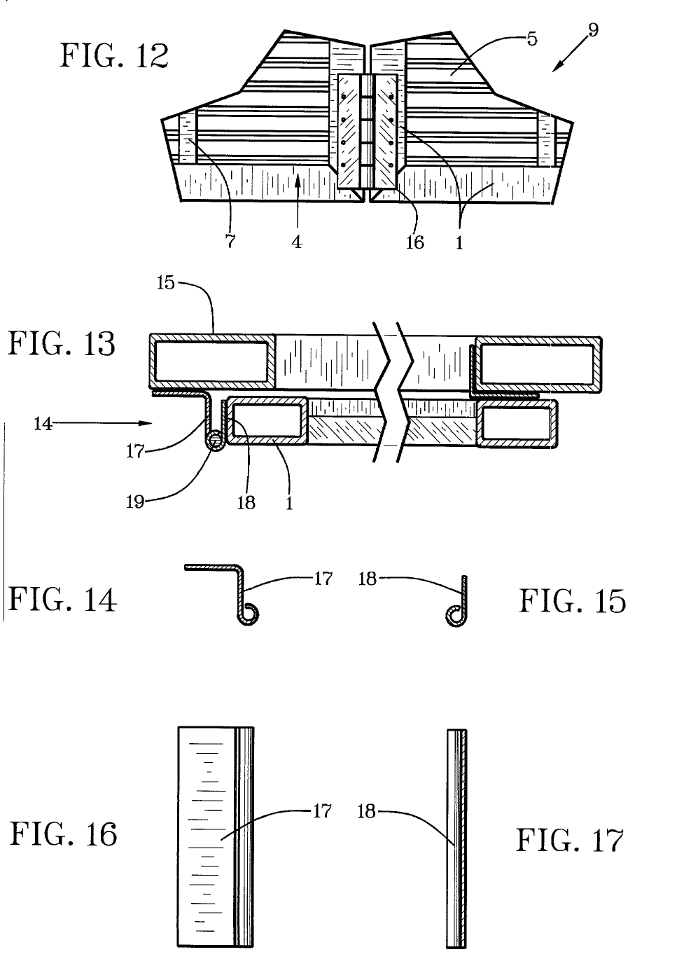

Referring to FIG. 12, the frame hinges 16 can include a selection of aluminum hinges and other frame-fold hinges which can be positioned in accordance with folding characteristics of Colonial Shutters. The frame hinges 16 in this illustration are shown on back sides of the shutter framework 1 with the slanted slats 5 and the slat-support mullions 7 being seen in front of the slanted slats 5.

Referring to FIGS. 13-19, the shutter hinge 14 is a preferred hinge that can be used either horizontally for hang-hinging Bahama Shutters 8 or vertically for swing-hinging Colonial Shutters 9. For the Colonial Shutters 9, the shutter hinge 14 can be swing-hinged and include a fold-back mode with structure wings 17 attached to the Colonial-shutter frame 15 and with frame wings 18 attached to the shutter framework 1 and joined by a shutter-hinge bolt 19 as depicted in FIG. 19.

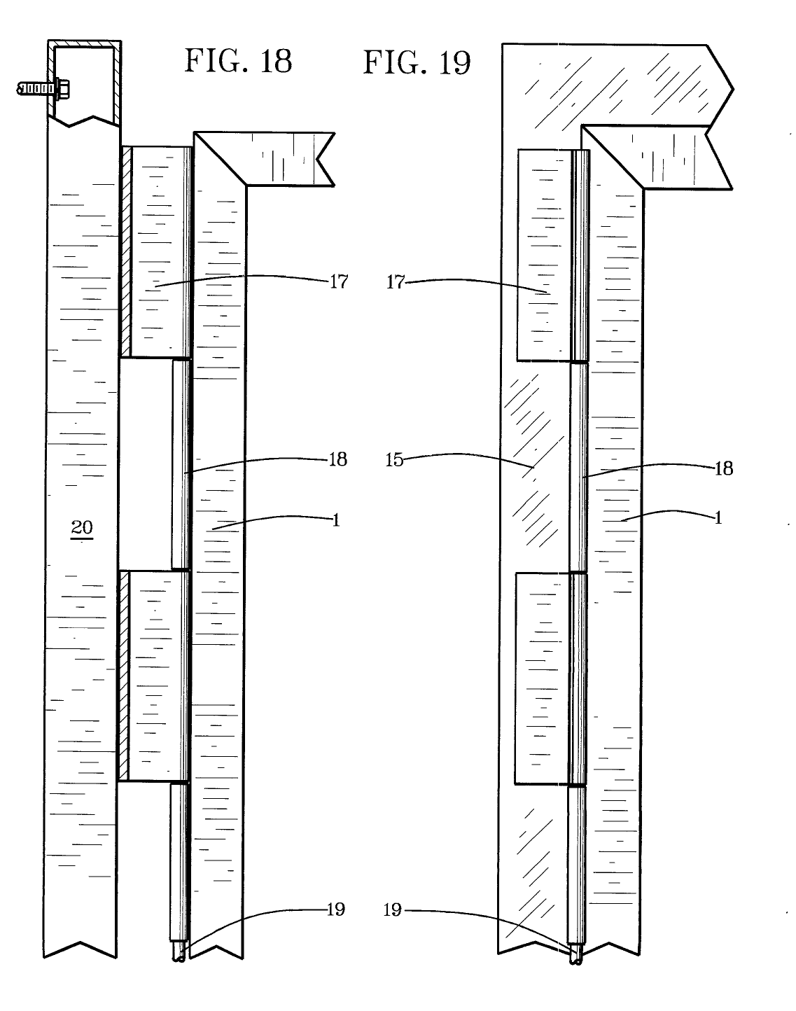

As shown in FIGS. 6-9 and 18 for the Bahama Shutters 8, the shutter hinge 14 can be hang-hinged and include a hanging mode with structure wings 17 attached to a hang structure 20 which can include the shutter Frame 11, the wooden structure 12 and the concrete frame 13 selectively. The frame wings 18 are attached to the shutter framework 1 and joined by a shutter-hinge bolt 19 as depicted in FIG. 18.

The structure wings 17 and the frame wings 18 of the shutter hinges 14 are made preferably of structural aluminum alloy 6063-T5, 6061-T6 or a substantial equivalent. As for other metallic components, the substantial equivalent can be a ferrous alloy that is preferably stainless and rustproof with either an adequate coating or having suitably alloyed content of nickel, chrome, aluminum and/or other stainless constituent.

A new and useful pressure-vent hurricane shutter having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A pressure-vent hurricane shutter comprising:
at least one shutter framework encompassing slatted-louver apertures;
the shutter framework including structural beams to which ends of slanted slats for the slatted-louver apertures are affixed;
slat-support mullions oriented vertically and having ends attached to horizontal portions of the shutter framework;
the slanted slats having inward edges that are oriented orthogonally to the slat-support mullions;
the inward edges intermediate the ends of the slanted slats being attached to the slat-support mullions;
at least one shutter hinge proximate at least one edge of the shutter framework;
the shutter framework being hinged to at least one structural member of a building proximate a building aperture;
the shutter framework, the slanted slats, the mullions, the hinge and inter-structural attachments thereof having a structural composite that has at least predetermined legally requisite strength for shutter-related protection of the building against storm-borne objects, wind and rain; and
the slatted-louver apertures having predetermined venting of storm buildups and bursts of pressure and vacuum that react on buildings.

2. The pressure-vent hurricane shutter of claim 1 wherein:
the structural beams included in the shutter framework are structural metal tubes having a cross section that is rectangular; and
a metal of which the structural metal tubes are made has predetermined material strength, rigidity, thickness and structure for the shutter framework to have the structural composite with at least the legally requisite strength for shutter-related protection of the building against storm-borne objects, wind and rain.

3. The pressure-vent hurricane shutter of claim 1 wherein:
the structural beams included in the shutter framework are structural aluminum tubes having a cross section that is rectangular with face walls being about two inches wide and orthogonal edge walls being about one and one-half inches wide;
the face walls and the edge walls being about one-eighth of an inch thick;
the metal of the structural aluminum tubes being aluminum alloy 6063-T52 or at least a substantial equivalent thereof; and
the structural beams of the shutter framework are welded together at joining edges in accordance with applicable predetermined standards for welding.

4. The pressure-vent hurricane shutter of claim 1 wherein:
the slanted slats include structural flat-bar metal having a cross section that is rectangular; and
a metal of which the slanted slats are made has predetermined material strength, rigidity, thickness and structure for the slanted slats to have the structural composite with at least the legally requisite strength for slatted-louver protection of the building against storm-borne objects, wind and rain.

5. The pressure-vent hurricane shutter of claim 1 wherein:
the slanted slats are structural aluminum flat bar having a cross section that is rectangular with face walls being about one inch wide and edge walls being about one-quarter of an inch wide;
the slanted slats being about one-quarter of an inch thick;
the metal of the slanted slats being aluminum alloy 6063-T52 or at least a substantial equivalent thereof;
the ends of the slanted slats are welded to the shutter framework in accordance with applicable predetermined standards for welding;
the slat-support mullions are structural aluminum alloy 6063-T52 or at least a substantial equivalent thereof having rectangular cross section with a width of about one inch and a thickness of about one-half inch;
the slat-support mullions have ends which are welded to the shutter framework in accordance with applicable predetermined standards for welding; and
the inward edges of the slanted slats are welded to the slat-support mullions in accordance with applicable predetermined standards for welding.

6. The pressure-vent hurricane shutter of claim 1 wherein:
the face walls of the slanted slats are spaced apart about one-half inch; and
the slanted slats are juxtaposed vertically with dihedral angles of the face walls and dihedral angles of the edge walls being horizontal.

7. The pressure-vent hurricane shutter of claim 1 wherein:
the shutter framework is sized, shaped and designed predeterminedly for a Bahama Shutter having top-hinge with which it is hinged to the structural member of the building proximate the building aperture.

8. The pressure-vent hurricane shutter of claim 1 wherein:
the shutter framework is sized, shaped and designed predeterminedly for a Colonial Shutter having side-hinges with which it is hinged to sides of the structural member of the building proximate the building aperture.

9. A pressure-vent hurricane shutter comprising:
at least one shutter framework encompassing slatted-louver apertures;
the shutter framework including structural beams to which ends of slanted slats for the slatted-louver apertures are affixed;
slat-support mullions oriented vertically and having ends attached to horizontal portions of the shutter framework;
the slanted slats having inward edges that are oriented orthogonally to the slat-support mullions;
the inward edges intermediate the ends of the slanted slats being attached to the slat-support mullions;
at least one shutter hinge proximate at least one edge of the shutter framework;
the shutter framework being hinged to at least one structural member of a building proximate a building aperture;
the shutter framework, the slats, the mullions, the hinge and inter-structural attachments thereof having a structural composite that has at least predetermined strength for shutter-related protection of the building against storm-borne objects, wind and rain; and
the slatted-louver apertures having predetermined venting of storm buildups and bursts of pressure and vacuum that react on buildings.

10. The pressure-vent hurricane shutter of claim 9 wherein:
the structural beams included in the shutter framework are structural metal tubes having a cross section that is rectangular; and
a metal of which the structural metal tubes are made has predetermined material strength, rigidity, thickness and structure for the shutter framework to have the structural composite with at least the predetermined strength for shutter-related protection of the building against storm-borne objects, wind and rain.

11. The pressure-vent hurricane shutter of claim 9 wherein:
the structural beams included in the shutter framework are structural aluminum tubes having a cross section that is rectangular with face walls being about two inches wide and orthogonal edge walls being about one and one-half inches wide;
the face walls and the edge walls being about one-eighth of an inch thick;
the metal of the structural aluminum tubes being aluminum alloy 6063-T52 or at least a substantial equivalent thereof;
the structural beams of the shutter framework are welded together at joining edges in accordance with applicable predetermined standards for welding;
the slanted slats include structural flat-bar metal have a cross section that is rectangular;
a metal of which the slanted slats are made has predetermined material strength, rigidity, thickness and structure for the slanted slats to have the structural composite with at least the predetermined strength for slatted-louver protection of the building against storm-borne objects, wind and rain;
the slanted slats are structural aluminum flat bar having a cross section that is rectangular with face walls being about one inch wide and edge walls being about one-quarter of an inch wide;
the slanted slats being about one-quarter of an inch thick;
the metal of the slanted slats being aluminum alloy 6063-T52 or at least a substantial equivalent thereof;
the ends of the slanted slats are welded to the shutter framework in accordance with applicable predetermined standards for welding;
the slat-support mullions are structural aluminum alloy 6063-T52 or at least a substantial equivalent thereof having rectangular cross section with a width of about one inch and a thickness of about one-half inch;
the slat-support mullions have ends which are welded to the shutter framework in accordance with applicable predetermined standards for welding; and
the inward edges of the slanted slats are welded to the slat-support mullions in accordance with applicable predetermined standards for welding.

12. The pressure-vent hurricane shutter of claim 9 wherein:
the face walls of the slanted slats are slanted about forty-five degrees from the mullions which are oriented vertically; and
the face walls of the slanted slats are spaced apart about one-half inch orthogonally.

13. The pressure-vent hurricane shutter of claim 9 wherein:
the shutter framework is sized, shaped and designed predeterminedly for a Bahama Shutter having top-hinge attachment to a top of the structural member of the building proximate the building aperture.

14. The pressure-vent hurricane shutter of claim 9 wherein:
the shutter framework is sized, shaped and designed predeterminedly for a Colonial Shutter having side-hinge attachment to sides of the structural member of the building proximate the building aperture.

15. A pressure-vent hurricane shutter comprising:
at least one shutter framework encompassing slatted-louver apertures;
the shutter framework being sized, shaped and designed predeterminedly for a Bahama Shutter having top-hinge attachment to a top of the structural member of the building proximate the building aperture;
the shutter framework including structural beams to which ends of slanted slats for the slatted-louver apertures are affixed and to which ends of slat-support mullions are attached orthogonally to the slanted slats intermediate the ends of inward edges of the slanted slats;
the shutter framework, the slats, the mullions, the hinge and inter-structural attachments thereof having a structural composite that has at least predetermined strength for shutter-related protection of the building against storm-borne objects, wind and rain;
the slatted-louver apertures having predetermined venting of storm buildups and bursts of pressure and vacuum that react on buildings;
the structural beams included in the shutter framework are structural metal tubes having a cross section that is rectangular; and
a metal of which the structural metal tubes are made has predetermined material strength, rigidity, thickness and structure for the shutter framework to have the structural composite with at least the predetermined strength for shutter-related protection of the building against storm-borne objects, wind and rain.

16. The pressure-vent hurricane shutter of claim 15 wherein:
the structural beams included in the shutter framework are structural aluminum tubes having a cross section that is rectangular with face walls being about two inches wide and orthogonal edge walls being about one and one-half inches wide;
the face walls and the edge walls being about one-eighth of an inch thick;
the metal of the structural aluminum tubes being aluminum alloy 6063-T52 or at least a substantial equivalent thereof;
the structural beams of the shutter framework are welded together at joining edges in accordance with applicable predetermined standards for welding;
the slanted slats include structural flat-bar metal have a cross section that is rectangular;
a metal of which the slanted slats are made has predetermined material strength, rigidity, thickness and structure for the slanted slats to have the structural composite with at least the predetermined strength for slatted-louver protection of the building against storm-borne objects, wind and rain;
the slanted slats are structural aluminum flat bar having a cross section that is rectangular with face walls being about one inch wide and edge walls being about one-quarter of an inch wide;
the slanted slats being about one-quarter of an inch thick;
the metal of the slanted slats being aluminum alloy 6063-T52 or at least a substantial equivalent thereof;
the ends of the slanted slats are welded to the shutter framework in accordance with applicable predetermined standards for welding;
the slat-support mullions are structural aluminum alloy 6063-T52 or at least a substantial equivalent thereof having rectangular cross section with a width of about one inch and a thickness of about one-half inch;
the slat-support mullions have ends which are welded to the shutter framework in accordance with applicable predetermined standards for welding; and
the inward edges of the slanted slats are welded at midsections thereof to the slat-support mullions in accordance with applicable predetermined standards for welding.

17. The pressure-vent hurricane shutter of claim 15 wherein:
the face walls of the slanted slats are spaced apart about one-half inch orthogonally; and
the slanted slats are juxtaposed vertically with dihedral angles of the face walls and dihedral angles of the edge walls being horizontal.

18. A pressure-vent hurricane shutter comprising:
at least one shutter framework encompassing slatted-louver apertures;
the shutter framework being sized, shaped and designed predeterminedly for a Colonial Shutter having side-hinge attachment to sides of the structural member of the building proximate the building aperture;
the shutter framework including structural beams to which ends of slanted slats for the slatted-louver apertures are affixed and to which ends of slat-support mullions are attached orthogonally to the slanted slats intermediate the ends of inward edges of the slanted slats;
the shutter framework, the slats, the mullions, the hinge and inter-structural attachments thereof having a structural composite that has at least predetermined strength for shutter-related protection of the building against storm-borne objects, wind and rain;
the slatted-louver apertures having predetermined venting of storm buildups and bursts of pressure and vacuum that react on buildings;
the structural beams included in the shutter framework are structural metal tubes having a cross section that is rectangular; and
a metal of which the structural metal tubes are made has predetermined material strength, rigidity, thickness and structure for the shutter framework to have the structural composite with at least the predetermined strength for shutter-related protection of the building against storm-borne objects, wind and rain.

19. The pressure-vent hurricane shutter of claim 18 wherein:
the structural beams included in the shutter framework are structural aluminum tubes having a cross section that is rectangular with face walls being about two inches wide and orthogonal edge walls being about one and one-half inches wide;
the face walls and the edge walls being about one-eighth of an inch thick;
the metal of the structural aluminum tubes being aluminum alloy 6063-T52 or at least a substantial equivalent thereof;
the structural beams of the shutter framework are welded together at joining edges in accordance with applicable predetermined standards for welding;
the slanted slats include structural flat-bar metal have a cross section that is rectangular;
a metal of which the slanted slats are made has predetermined material strength, rigidity, thickness and structure for the slanted slats to have the structural composite with at least the predetermined strength for slatted-louver protection of the building against storm-borne objects, wind and rain;
the slanted slats are structural aluminum flat bar having a cross section that is rectangular with face walls being about one inch wide and edge walls being about one-quarter of an inch wide;
the slanted slats being about one-quarter of an inch thick;
the metal of the slanted slats being aluminum alloy 6063-T52 or at least a substantial equivalent thereof;
the ends of the slanted slats are welded to the shutter framework in accordance with applicable predetermined standards for welding;
the slat-support mullions are structural aluminum alloy 6063-T52 or at least a substantial equivalent thereof having rectangular cross section with a width of about one inch and a thickness of about one-half inch;
the slat-support mullions have ends which are welded to the shutter framework in accordance with applicable predetermined standards for welding; and
the inward edges of the slanted slats are welded to the slat-support mullions in accordance with applicable predetermined standards for welding.

20. The pressure-vent hurricane shutter of claim 18 wherein:
the face walls of the slanted slats are spaced apart about one-half inch orthogonally; and
the slanted slats are juxtaposed vertically with dihedral angles of the face walls and dihedral angles of the edge walls being horizontal.
